(19) United States
(12) Patent Application Publication
(10) Pub. No.: US 2015/0363101 A1
(43) Pub. Date: Dec. 17, 2015

(54) VIDEO SCROLLING SHORTCUTS FOR TOUCHSCREEN DISPLAY

(71) Applicant: LENOVO ENTERPRISE SOLUTIONS (SINGAPORE) PTE. LTD., New Tech Park (SG)

(72) Inventors: Barry A. Kritt, Atlantic Beach, NC (US); Sarbajit K. Rakshit, Kolkata (IN)

(21) Appl. No.: 14/303,681

(22) Filed: Jun. 13, 2014

(51) Int. Cl. G06F 3/0485; G11B 27/10; G11B 27/34; G06F 3/0488

(52) U.S. Cl. CPC G06F 3/04855; G06F 3/04886; G11B 27/102; G11B 27/34; G06F 3/04883

(57) ABSTRACT

Video content is displayed on a touchscreen display. A first touch gesture is received, while displaying the video content, which is associated with scrolling through the video content. A set of selectable shortcuts are displayed overlaying the video content in response to receiving the first touch gesture. Each selectable shortcut in the set of selectable shortcuts is associated with a time position. A second touch gesture is received selecting a selectable shortcut from the set of selectable shortcuts. The video content is displayed from the time position associated with the selected shortcut.

### BACKGROUND

The present disclosure relates to computer graphical user interfaces, and more specifically, to video scrolling shortcuts on a touchscreen computer display.

Many computing devices, including, but not limited to, desktop computers, mobile telephones, pad computers and notebook computers provide a graphical user interface (GUI) to facilitate interaction with the computing device. In addition, many of these devices provide touch screens, which enable a user to manipulate data by placing a finger or touch device, such as a stylus, on a display to make a touch gesture. For example, touch screens typically enable a user to scroll by touching the display and moving the finger in the desired scroll direction.

### SUMMARY

According to embodiments of the present disclosure, a method for providing scrolling shortcuts is disclosed. The method includes displaying video content on a touchscreen display. The method further includes receiving, while displaying the video content, a first touch gesture associated with scrolling through the video content. The method further includes displaying, in response to receiving the first touch gesture, a set of selectable shortcuts overlaying the video content. Each selectable shortcut in the set of selectable shortcuts is associated with a time position. The method further includes receiving a second touch gesture selecting a first selectable shortcut from the set of selectable shortcuts where the first selectable shortcut is associated with a first time position. The method further includes displaying the video content from the first time position.

Further disclosed herein are embodiments of a computer program product for providing scrolling shortcuts. The computer program product includes a computer readable storage medium having program code embodied therewith. The program code is executable by a computer to perform a method. The method includes displaying video content on a touchscreen display. The method further includes receiving, while displaying the video content, a first touch gesture associated with scrolling through the video content. The method further includes displaying, in response to receiving the first touch gesture, a set of selectable shortcuts overlaying the video content. Each selectable shortcut in the set of selectable shortcuts is associated with a time position. The method further includes receiving a second touch gesture selecting a first selectable shortcut from the set of selectable shortcuts where the first selectable shortcut is associated with a first time position. The method further includes displaying the video content from the first time position.

Further disclosed herein are embodiments of a computer system for providing scrolling shortcuts. The computer system includes one or more processors, one or more computer-readable memories, one or more computer-readable tangible storage devices, and program instructions stored on at least one of the one or more storage devices for execution by at least one of the one or more processors via at least one of the one or more memories. The program instructions include program instructions to display video content on a touchscreen display. The program instructions further include program instructions to receive, while displaying the video content, a first touch gesture associated with scrolling through the video content. The program instructions further include program instructions to display, in response to receiving the first touch gesture, a set of selectable shortcuts overlaying the video content. Each selectable shortcut in the set of selectable shortcuts is associated with a time position. The program instructions further include program instructions to receive a second touch gesture selecting a first selectable shortcut from the set of selectable shortcuts where the first selectable shortcut is associated with a first time position. The program instructions further include program instructions to display the video content from the first time position.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a flow diagram of an example method for providing scrolling shortcuts on a touchscreen display of a computer system.

FIG. 2 depicts a block diagram of an example computer system for providing scrolling shortcuts on a touchscreen display.

FIG. 3 depicts an example graphical user interface (GUI) for providing scrolling shortcuts on a touchscreen display.

FIG. 4 depicts a high-level block diagram of an example system for implementing one or more embodiments of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to video scrolling, and more particular aspects relate to video scrolling shortcuts on a touchscreen computer display. While the present disclosure is not necessarily limited to such applications, various aspects of the disclosure may be appreciated through a discussion of various examples using this context.

Typically, a GUI for displaying a video will include a scrollbar on a track which indicates the time position of the video. Scrolling through the video can be performed by selecting the scrollbar, dragging it in the direction of scrolling, and releasing the scrollbar to play the video from the time position indicated by the scrollbar. When the display is a touchscreen, scrolling may be performed by touching the scrollbar with a finger or touch device, sliding the finger or pointing device in the direction of scrolling, and removing the finger or pointing device from the screen to play the video from the time position indicated by the scrollbar. For example, to scroll forward in a video a user may touch the scrollbar with a finger, slide the finger across the screen to the right, and remove the finger when the scrollbar indicates the desired time position.

Embodiments of the present disclosure may provide shortcuts for scrolling through a video displayed on a touchscreen computer display. A computer touchscreen display may display a video. A user may use a touch gesture associated with scrolling. Any touch gesture for scrolling could be used including touching the screen with a finger and dragging the finger across the screen. Shortcuts may be displayed over the video which are selectable by the user. These shortcuts may be selected using a second touch gesture, for example, by touching a shortcut with a second finger or touch device. In some embodiments, the shortcuts are only available while the first touch gesture is being received (i.e. the finger or touch device is still touching the screen). In some embodiments, the shortcuts are available for a specified time period after the first touch gesture has been received (i.e. after the finger or touch device has been removed from the screen). This may allow for a user to use one finger or one touch device to perform the first touch gesture and the second touch gesture.

The shortcuts may be associated different time positions of the video and may be selected to jump to the associated time position. Some shortcuts may be based on a specified time period from the initial time position the video was at when scrolling was started. For example, the shortcut may be five minutes from the initial time position or 30 seconds from the initial time position. Some shortcuts may represent tagged time positions of the video. This may include tagged time positions that represent popular parts of the video or were user created to mark time positions for future viewing.

In some embodiments, the shortcuts displayed may be chosen based on the direction of scrolling. A user scrolling toward a later time position may be provided with shortcuts representing later time positions and a user scrolling toward an earlier time position may be provided with shortcuts representing earlier time positions. For example, a user may touch the scrollbar and drag it toward the right to advance the time position of the video to a later time position. The user may be provided with shortcuts associated with later time positions. Alternatively, the user may touch the scrollbar and drag it toward the left to move backwards to an earlier time position. The user may be provided with shortcuts associated with earlier time positions.

The display of the shortcuts may include text and/or thumbnail which indicate the time position associated with the shortcut. For example, a shortcut associated with a time position 30 seconds later from the current time position may include the text “30 seconds later” on the shortcut display. In another example, the shortcut display may include a thumbnail of an image associated with time position of the shortcut. This thumbnail may be of the image displayed by the video at the time position associated with the shortcut. Alternatively, the thumbnail may be of an image from a time position later than the time position associated with the shortcut. For example, the thumbnail may be of an image from the middle of a particular scene from the video and the shortcut may be associated with a time position which indicates the start of the scene.

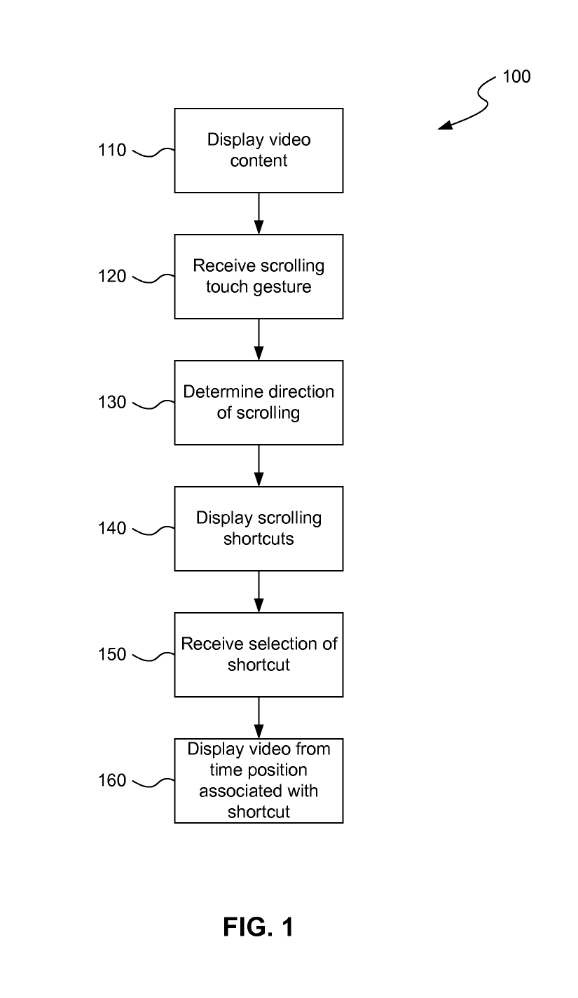

Referring to FIG. 1, a flow diagram of an example method 100 for providing scrolling shortcuts on a touchscreen display of a computer system is depicted. At block 110, the computing system may display video content. At block 120, a first touch gesture may be received on the touchscreen which indicates scrolling through the video. At block 130, the direction of scrolling may be determined from the first touch gesture. At block 140, the computer system displays scrolling shortcuts. These shortcuts may be chosen based on the determined direction of scrolling. At block 150, a second touch gesture is received on the touchscreen indicating selection of a scrolling shortcut. At block 160, the video content is displayed from the time position associated with the selected scrolling shortcut.

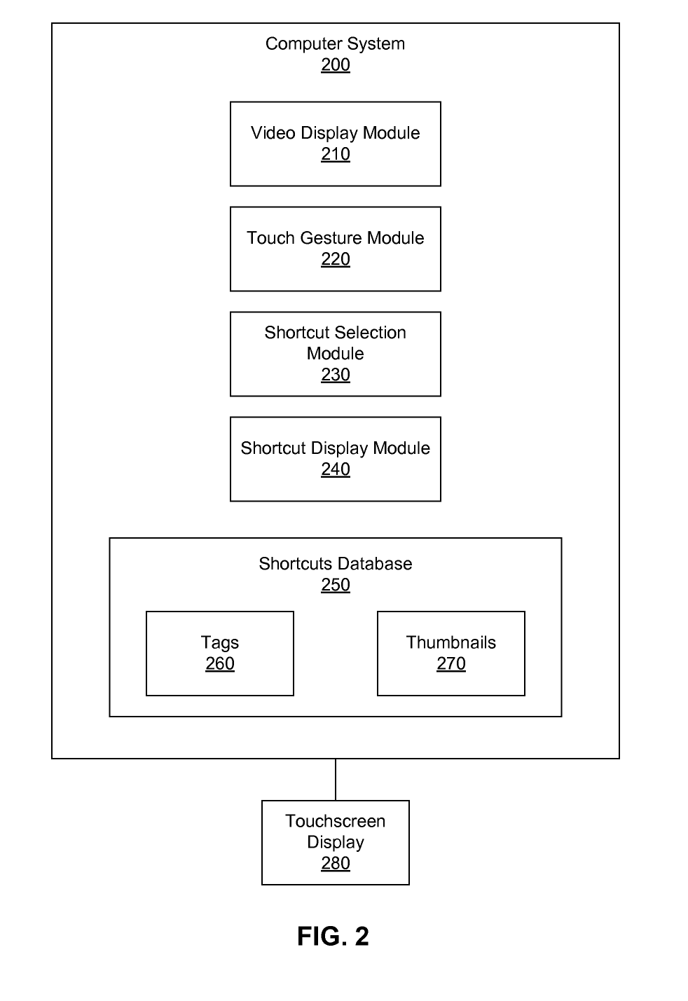

Referring to FIG. 2, a block diagram of an example computer system 200 for providing scrolling shortcuts on a touchscreen display 280 is depicted. Computer system 200 includes video display module 210, touch gesture module 220, shortcut selection module 230, shortcut display module 240, and shortcuts database 250. Video display module 210 may be configured to display video content on touchscreen display 280. Touch gesture module 220 may be configured to receive touch gestures from touchscreen display 280, including touch gestures associated with scrolling through video content and selecting shortcuts. Shortcut selection module 230 may be configured to select scrolling shortcuts. Selection of scrolling shortcuts may be based on the direction of scrolling. Shortcut selection module 230 may determine scrolling shortcuts by identifying tags 260 and thumbnails 270 associated with time positions in the direction of scrolling. Shortcut display module 240 may be configured to display selectable scrolling shortcuts overlaying the video display.

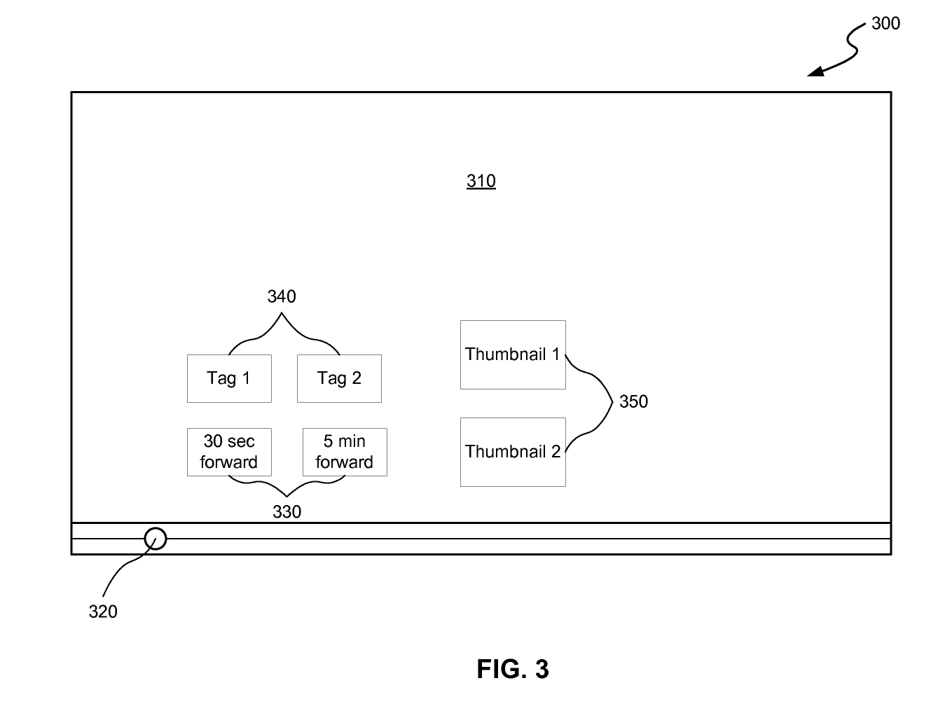

Referring to FIG. 3, an example graphical user interface (GUI) 300 for providing scrolling shortcuts on a touchscreen display is depicted. GUI 300 includes video display area 310, scrollbar 320, time period shortcuts 330, tagged shortcuts 340, and thumbnail shortcuts 350. Scrolling shortcuts 330, 340, and 350 may be displayed only when a user is scrolling through the video content. In some embodiments, shortcuts 330, 340, and 350 will continue to be displayed for a period of time after the user has completed scrolling. As depicted, time period shortcuts 330 are associated with a later time position. Time period shortcuts 330 associated with a later time position may be chosen when a user is scrolling toward a later time position. For example, time period shortcuts 330 associated with a later time position may be displayed when a user touches scrollbar 320 with their finger and slides their finger to the right. Time period shortcuts 330 may similarly be associated with an earlier time position when the user is scrolling to the left. Tagged shortcuts 340 and thumbnail shortcuts 350 may similarly be chosen based on the direction of scrolling such that they are associated with time positions in the direction of scrolling.

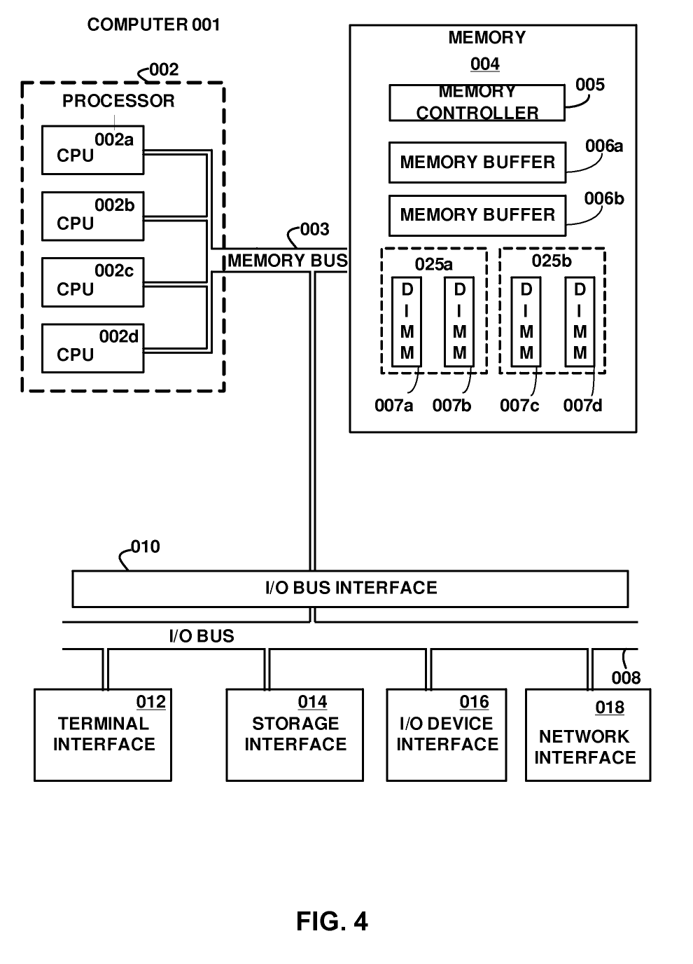

Referring to FIG. 4, a high-level block diagram of an example system for implementing one or more embodiments of the invention is depicted. The mechanisms and apparatus of embodiments of the present invention apply equally to any appropriate computing system. The major components of the computer system 001 comprise one or more CPUs 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffer 006 and one or more memory devices 007. In the illustrated embodiment, the memory devices 007 may be dual in-line memory modules (DIMMs), which are a series of dynamic random-access memory (DRAM) chips mounted on a printed circuit board and designed for use in personal computers, workstations, and servers. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 4 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 4 is intended to depict the representative major components of an exemplary computer system 001. But individual components may have greater complexity than represented in FIG. 4, components other than or in addition to those shown in FIG. 4 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for providing scrolling shortcuts, the method comprising:
displaying video content on a touchscreen display;
receiving, while displaying the video content, a first touch gesture associated with scrolling through the video content;
displaying, in response to receiving the first touch gesture, a set of selectable shortcuts overlaying the video content, each selectable shortcut in the set of selectable shortcuts associated with a time position;
receiving a second touch gesture selecting a first selectable shortcut from the set of selectable shortcuts, the first selectable shortcut associated with a first time position; and
displaying the video content from the first time position.

2. The method of claim 1, further comprising:
displaying a scrollbar indicating the current time position of the video content, wherein the first touch gesture is touching and dragging the scrollbar.

3. The method of claim 1, wherein the first time position is a specified time period from an initial time position when the first touch gesture was initially received.

4. The method of claim 1, wherein the first time position is a tagged time position.

5. The method of claim 1, wherein the first selectable shortcut from the set of selectable shortcuts is a thumbnail of the video content at the first time position.

6. The method of claim 1, further comprising:
determining a direction of scrolling associated with the first touch gesture; and
generating the set of selectable shortcuts based on the direction of scrolling.

7. The method of claim 1, wherein the first touch gesture is still being received when the second touch gesture is received.

8. A computer program product for providing scrolling shortcuts, the computer program product comprising a computer readable storage medium having program code embodied therewith, the program code executable by a computer to perform a method comprising:
displaying video content on a touchscreen display;
receiving, while displaying the video content, a first touch gesture associated with scrolling through the video content;
displaying, in response to receiving the first touch gesture, a set of selectable shortcuts overlaying the video content, each selectable shortcut in the set of selectable shortcuts associated with a time position;
receiving a second touch gesture selecting a first selectable shortcut from the set of selectable shortcuts, the first selectable shortcut associated with a first time position; and
displaying the video content from the first time position.

9. The computer program product of claim 8, wherein the method further comprises:
displaying a scrollbar indicating the current time position of the video content, wherein the first touch gesture is touching and dragging the scrollbar.

10. The computer program product of claim 8, wherein the first time position is a specified time period from an initial time position when the first touch gesture was initially received.

11. The computer program product of claim 8, wherein the first time position is a tagged time position.

12. The computer program product of claim 8, wherein the first selectable shortcut from the set of selectable shortcuts is a thumbnail of the video content at the first time position.

13. The computer program product of claim 8, wherein the method further comprises:
determining a direction of scrolling associated with the first touch gesture; and
generating the set of selectable shortcuts based on the direction of scrolling.

14. The computer program product of claim 8, wherein the first touch gesture is still being received when the second touch gesture is received.

15. A computer system for providing scrolling shortcuts, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to display video content on a touchscreen display;
program instructions to receive, while displaying the video content, a first touch gesture associated with scrolling through the video content;
program instructions to display, in response to receiving the first touch gesture, a set of selectable shortcuts overlaying the video content, each selectable shortcut in the set of selectable shortcuts associated with a time position;
program instructions to receive a second touch gesture selecting a first selectable shortcut from the set of selectable shortcuts, the first selectable shortcut associated with a first time position; and
program instructions to display the video content from the first time position.

16. The computer system of claim 15, wherein the program instructions for execution further comprise:
program instructions to display a scrollbar indicating the current time position of the video content, wherein the first touch gesture is touching and dragging the scrollbar.

17. The computer system of claim 15, wherein the first time position is a specified time period from an initial time position when the first touch gesture was initially received.

18. The computer system of claim 15, wherein the first time position is a tagged time position.

19. The computer system of claim 15, wherein the first selectable shortcut from the set of selectable shortcuts is a thumbnail of the video content at the first time position.

20. The computer system of claim 15, wherein the program instructions for execution further comprise:
program instructions to determine a direction of scrolling associated with the first touch gesture; and
program instructions to generate the set of selectable shortcuts based on the direction of scrolling.
